(19) United States
(12) Patent Application Publication
(10) Pub. No.: US 2025/0300845 A1
(43) Pub. Date: Sep. 25, 2025

(54) OBTAINING A CERTIFICATE FOR A DEVICE

(71) Applicant: ASSA ABLOY AB, Stockholm (SE)

(72) Inventors: Felix Grape, Lidingö (SE); Daniel Lind, Hägersten (SE); Erik Borgström, Rönninge (SE); Jens Patrik Byléhn, Sollentuna (SE)

(21) Appl. No.: 18/612,368

(22) Filed: Mar. 21, 2024

(51) Int. Cl. H04L 9/32; H04L 9/30

(52) U.S. Cl. CPC H04L 9/3268; H04L 9/3073; H04L 9/3213

(57) ABSTRACT

It is provided a method for obtaining a certificate for a device of a system comprising the device and a server. The method is performed by the server. The method comprises: providing a token message comprising a session token to a trusted party; receiving a validation message comprising data based on the session token and a public key of a key pair of the device, the key pair comprising the public key and a private key; validating the device, which comprises validating that the received data based on the session token corresponds to the session token provided to the trusted party; sending a server message to the device; receiving a certificate request comprising a cryptographic signature; validating that the cryptographic signature is a signature of the server message, based on the public key; obtaining a certificate from a certificate authority server; and sending the certificate to the device.

### TECHNICAL FIELD

The present disclosure relates to the field of certificates, and in particular to how certificates are provisioned (i.e., provided) to devices.

### BACKGROUND

In the realm of digital communication and information technology, ensuring the security and integrity of data exchange between devices is paramount. This is particularly vital in systems where sensitive information or control commands are transmitted, such as electronic access systems for physical access control. The traditional approach to secure such exchanges involves the use of digital certificates, which serve as a means to verify the identity of the devices involved in the communication. These certificates can be issued by trusted entities known as Certificate Authorities (CAs).

However, the conventional mechanisms for certificate issuance have several limitations, especially in scenarios involving a vast array of devices with varying levels of capabilities. One significant challenge is ensuring that certificates are issued exclusively to devices that are deemed trustworthy. This is increasingly difficult in the context of the Internet of Things (IoT), where the sheer number and diversity of devices present substantial security management challenges. Existing systems are known to pre-issue a large number of certificates that are used one by one per device as needed during production, but such a solution is vulnerable to a security breach where an attacker could use such pre-issued certificates for illegitimate purposes.

### SUMMARY

One object is to provide a way to provide certificates in a more controlled and on-demand manner.

According to a first aspect, it is provided a method for obtaining a certificate for a device, the method being performed by a system comprising the device and a server, the method comprising: receiving, by the server, a token request for a session token from a trusted party; obtaining, by the server, a session token; providing, by the server, a token message comprising the session token to the trusted party; receiving, by the device, the token message from the trusted party; providing, by the device, a public key of a key pair comprising the public key and a corresponding a private key; receiving, by the server, a validation message comprising the public key and the session token from the device; validating that the received session token matches the session token provided to the trusted party; sending, by the server, a server message to the device; generating, by the device, a cryptographic signature of the server message based on the private key; receiving, by the server, a certificate request comprising the cryptographic signature; validating, by the server, the cryptographic signature based on the public key; obtaining, by the server, a certificate from a certificate authority server; and sending, by the server, the certificate to the device.

According to a second aspect, it is provided a method for obtaining a certificate for a device of a system comprising the device and a server. The method is performed by the server. The method comprises: providing a token message comprising a session token to a trusted party; receiving a validation message comprising data based on the session token and a public key of a key pair of the device, the key pair comprising the public key and a private key; validating the device, which comprises validating that the received data based on the session token corresponds to the session token provided to the trusted party; sending a server message to the device; receiving a certificate request comprising a cryptographic signature; validating that the cryptographic signature is a signature of the server message, based on the public key; obtaining a certificate from a certificate authority server; and sending the certificate to the device.

The method may further comprise: receiving a token request for a session token from a trusted party; and obtaining a session token; wherein the token message comprises the obtained session token.

The validating the device may comprise validating that the session token has not been used before by the server when obtaining a certificate.

The method may further comprise: receiving an attestation token for authenticating the device; and wherein the validating the device comprises validating the attestation token.

The token message may further comprises a nonce, in which case the attestation token is an entity attestation token comprising the nonce.

The validating may comprise validating that the attestation token indicates that a source of an application of the device that sends the validation message matches a list of at least one pre-defined valid application.

The token request may comprise configuration details for the certificate.

The data based on the session token may be the session token, in which case the validating that the received data comprises matching the received session token against the session token provided to the trusted party.

The data based on the session token may be a signature based on the session token, and the validating that the received data may comprise matching the signature against the session token provided to the trusted party.

According to a third aspect, it is provided a server for obtaining a certificate for a device of a system comprising the device and the server. The server comprises: processing circuitry; and memory circuitry storing instructions that, when executed by the processing circuitry, cause the server to: provide a token message comprising the session token to a trusted party; receive a validation message comprising data based on the session token and a public key of a key pair of the device, the key pair comprising the public key and a private key; validate the device, which comprises validating that the received session data based on the session token corresponds to the session token provided to the trusted party; send a server message to the device; receive a certificate request comprising a cryptographic signature; validate that the cryptographic signature is a signature of the server message, based on the public key; obtain a certificate from a certificate authority server; and send the certificate to the device.

The server may further comprise instructions that, when executed by the processing circuitry, cause the server to: receive a token request for a session token from a trusted party; and obtain a session token; wherein the token message comprises the obtained session token.

The instructions to validate the device may comprise instructions that, when executed by the processing circuitry, cause the server to validate that the session token has not been used before by the server when obtaining a certificate.

The server may further comprise instructions that, when executed by the processing circuitry, cause the server to: receive an attestation token for authenticating the device; and wherein the instructions to validate the device comprise instructions that, when executed by the processing circuitry, cause the server to validate the attestation token.

The token message may further comprise a nonce, and the attestation token is an entity attestation token comprising the nonce.

The instructions to validate may comprise instructions that, when executed by the processing circuitry, cause the server to validate that the attestation token indicates that a source of an application of the device that sends the validation message matches a list of at least one pre-defined valid application.

The token request may comprise configuration details for the certificate.

The data based on the session token may be the session token, in which case the instructions to validate that the received data comprise instructions that, when executed by the processing circuitry, cause the server to match the received session token against the session token provided to the trusted party.

According to a fourth aspect, it is provided a computer program for obtaining a certificate for a device of a system comprising the device and a server, the computer program comprising computer program code which, when executed on the server, causes the server to: provide a token message comprising the session token to a trusted party; receive a validation message comprising the session token and a public key of a key pair of the device, the key pair comprising the public key and a private key; validate the device, which comprises validating that the received session token matches the session token provided to the trusted party; send a server message to the device; receive a certificate request comprising a cryptographic signature; validate that the cryptographic signature is a signature of the server message, based on the public key; obtain a certificate from a certificate authority server; and send the certificate to the device.

According to a fifth aspect, it is provided a computer program product comprising a computer program according to the fourth aspect and a computer readable means comprising non-transitory memory in which the computer program is stored.

According to a sixth aspect, it is provided a method for obtaining a certificate for a device of a system comprising the device and a server, the method being performed by the device, the method comprises: receiving a token message from a trusted party, the token message comprising a session token; providing, by the device, a public key of a key pair comprising the public key and a corresponding private key; generating and transmitting a validation message, wherein the validation message comprises the session token and the public key; receiving a server message from the server; generating a cryptographic signature of the server message based on the private key; sending a certificate request to the server, wherein the certificate request comprises the cryptographic signature; and receiving the certificate.

The providing a public key may comprise generating the key pair comprising the public key and the private key.

The providing a public key may comprise providing the attestation token to the trusted device, wherein the attestation token comprises a public key for the device.

According to a seventh aspect, it is provided a device for obtaining a certificate for a device of a system comprising the device and a server, the device comprising: processing circuitry; and memory circuitry storing instructions that, when executed by the processing circuitry, cause the device to: receive a token message from a trusted party, the token message comprising a session token; provide, by the device, a public key of a key pair comprising the public key and a corresponding a private key; generate and transmit a validation message, wherein the validation message comprises the session token and the public key; receive a server message from the server; generate a cryptographic signature of the server message based on the private key; send a certificate request to the server, wherein the certificate request comprises the cryptographic signature; and receive the certificate to the device.

According to an eighth aspect, it is provided a computer program for obtaining a certificate for a device of a system comprising the device and a server, the computer program comprising computer program code which, when executed on the device causes the device to: receive a token message from a trusted party, the token message comprising a session token; provide, by the device, a public key of a key pair comprising the public key and a corresponding a private key; generate and transmit a validation message, wherein the validation message comprises the session token and the public key; receive a server message from the server; generate a cryptographic signature of the server message based on the private key; send a certificate request to the server, wherein the certificate request comprises the cryptographic signature; and receive the certificate to the device.

According to a ninth aspect, it is provided a computer program product comprising a computer program according to the eighth aspect and a computer readable means comprising non-transitory memory in which the computer program is stored.

Generally, all terms used in the claims are to be interpreted according to their ordinary meaning in the technical field, unless explicitly defined otherwise herein. All references to a/an/the element, apparatus, component, means, step, etc. are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

Aspects and embodiments are now described, by way of example, with reference to the accompanying drawings, in which:

FIG. 1 is a schematic diagram illustrating an environment in which embodiments presented herein can be applied for obtaining a certificate for a device;

FIGS. 2A-2B are swimlane diagrams illustrating communication between various entities of embodiments which can be applied in the environment of FIG. 1 for obtaining a certificate for the device;

FIG. 3 is a schematic diagram illustrating components of the device and the server of FIG. 1; and

FIG. 4 shows one example of a computer program product 90 comprising computer readable means.

### DETAILED DESCRIPTION

The aspects of the present disclosure will now be described more fully hereinafter with reference to the accompanying drawings, in which certain embodiments of the invention are shown. These aspects may, however, be embodied in many different forms and should not be construed as limiting; rather, these embodiments are provided by way of example so that this disclosure will be thorough and complete, and to fully convey the scope of all aspects of invention to those skilled in the art. Like numbers refer to like elements throughout the description.

According to embodiments presented herein, it is provided a way for providing a certificate to a device, where control over the certificate provisioning is improved. Specifically, a server is provided that exploits a session token and verification of private key possession of the device to authenticate the device and to control access to certificate provisioning.

The embodiments presented herein enable an automated process to generate (at most) exactly one certificate of a specific type. When attestation is optionally applied, this ensures that certificates are only generated for trusted devices (mobile and embedded). Moreover, the provided embodiments provide access to multiple CAs in a way that is transparent to the devices.

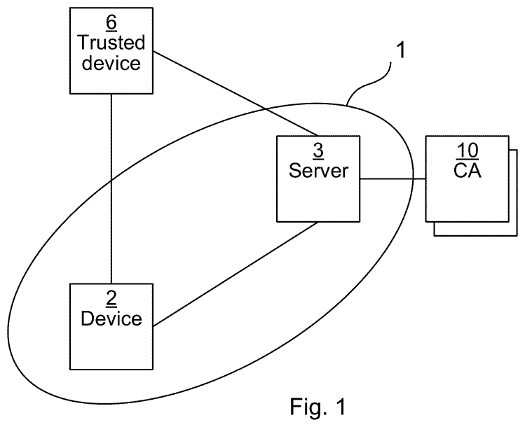

FIG. 1 is a schematic diagram illustrating an environment in which embodiments presented herein can be applied for obtaining a certificate for a device 2. The device can be any suitable device with processing capability for which a certificate is to be provided. For instance, the device 2 can be a purpose-built device such as an electronic lock, access controller for physical access, or similar. Alternatively, the device 2 is in the form of a general-purpose device, such as a smartphone, wearable device, tablet computer, laptop computer, etc. In this case, for purposes herein, the device 2 corresponds to a particular application (also known as an app) executing on such a device 2.

One or more certificate authorities (CAs) 10 are the entities that generate the certificates for certifying an identity of a device 2, as known in the art per se. According to embodiments presented herein, a server 3 is provided. The server 3 is used, as described in more detail below, to validate the device and control the issuing of certificates.

A trusted device 6 is trusted by the server 3, for example, by authentication with the server 3 by a previously verified certificate for the trusted device 6. The trusted device 6 can, for example, be in the form of a computer. The trusted device 6 obtains a session token from the server 3, which is later used by the device 2 in communication with the server 3.

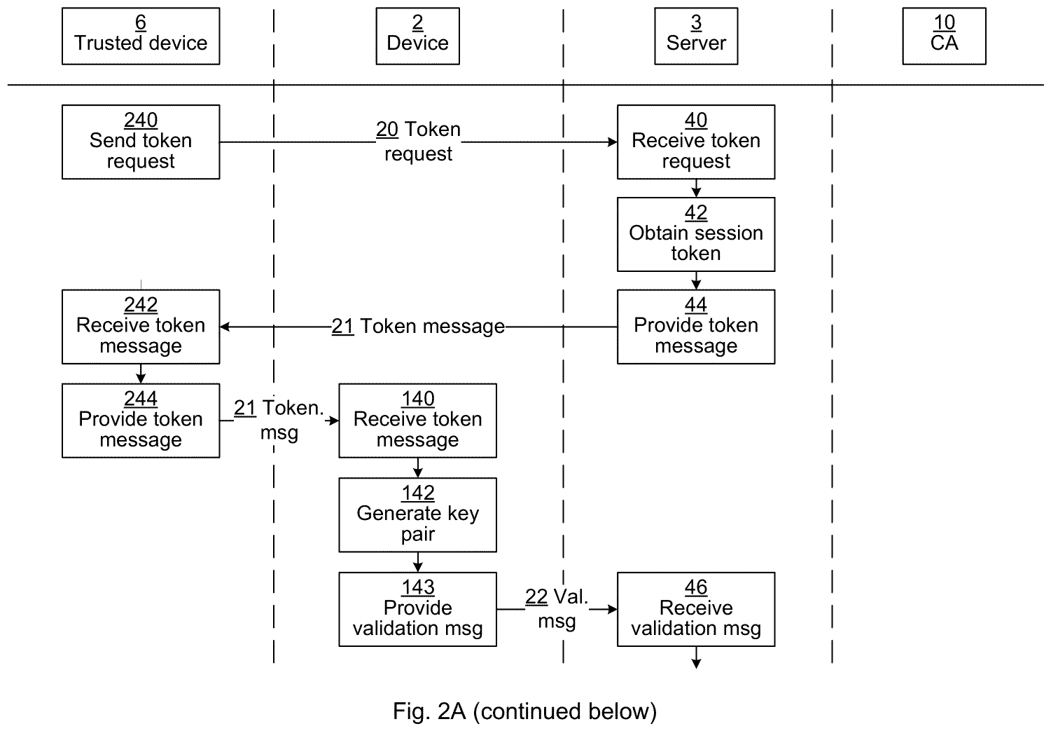

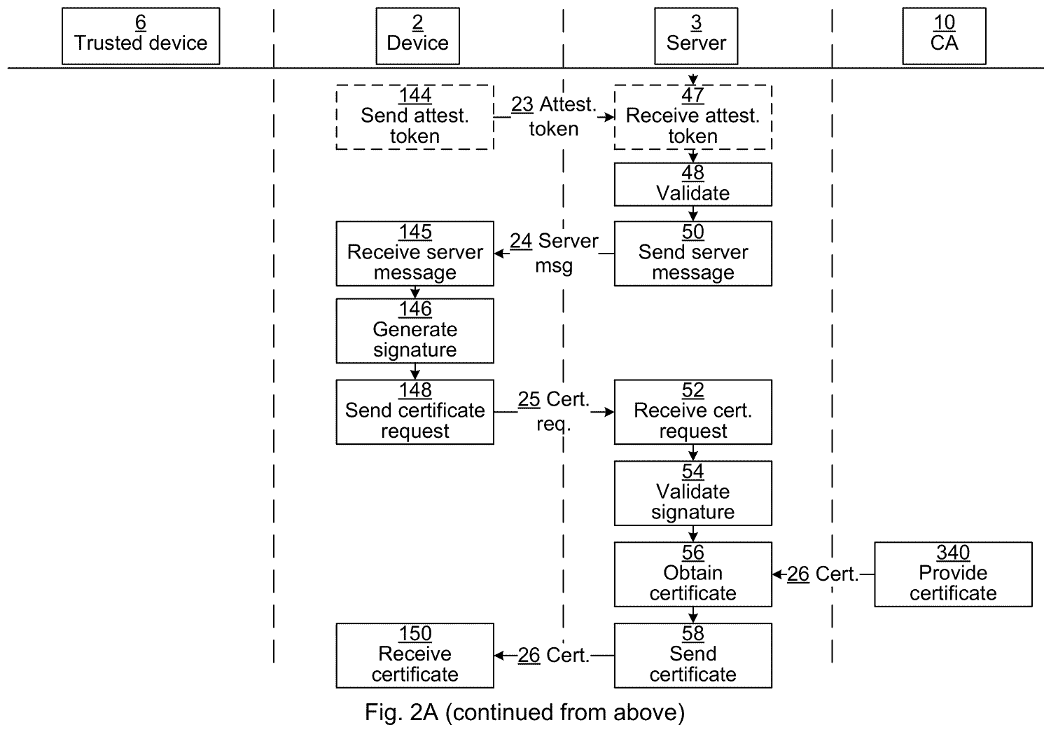

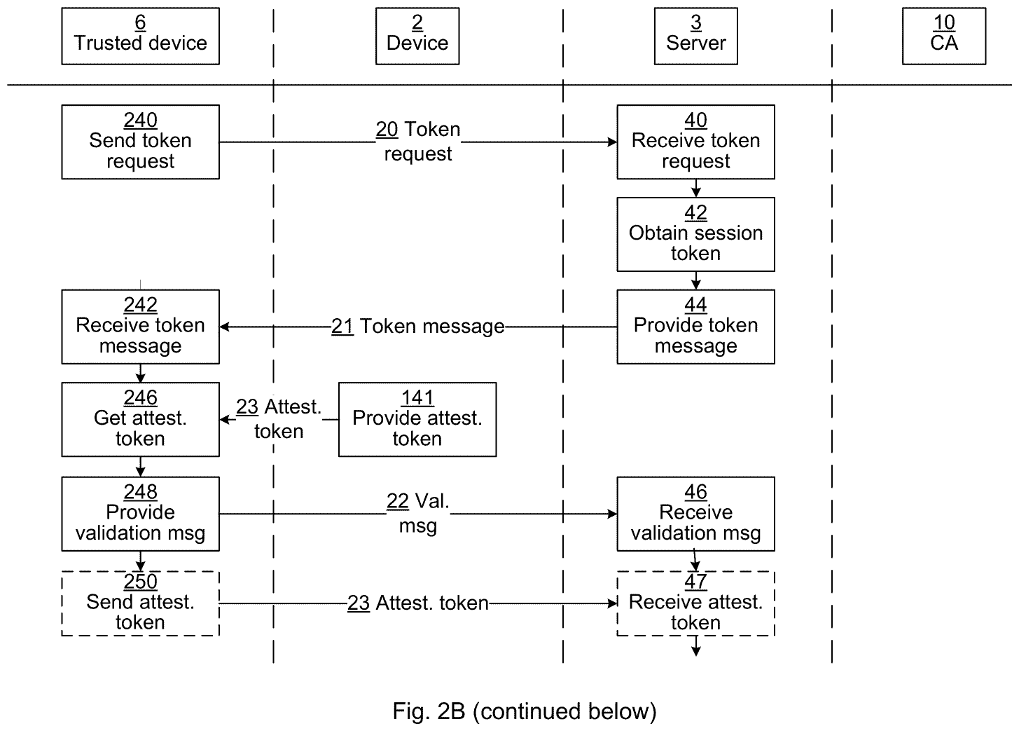

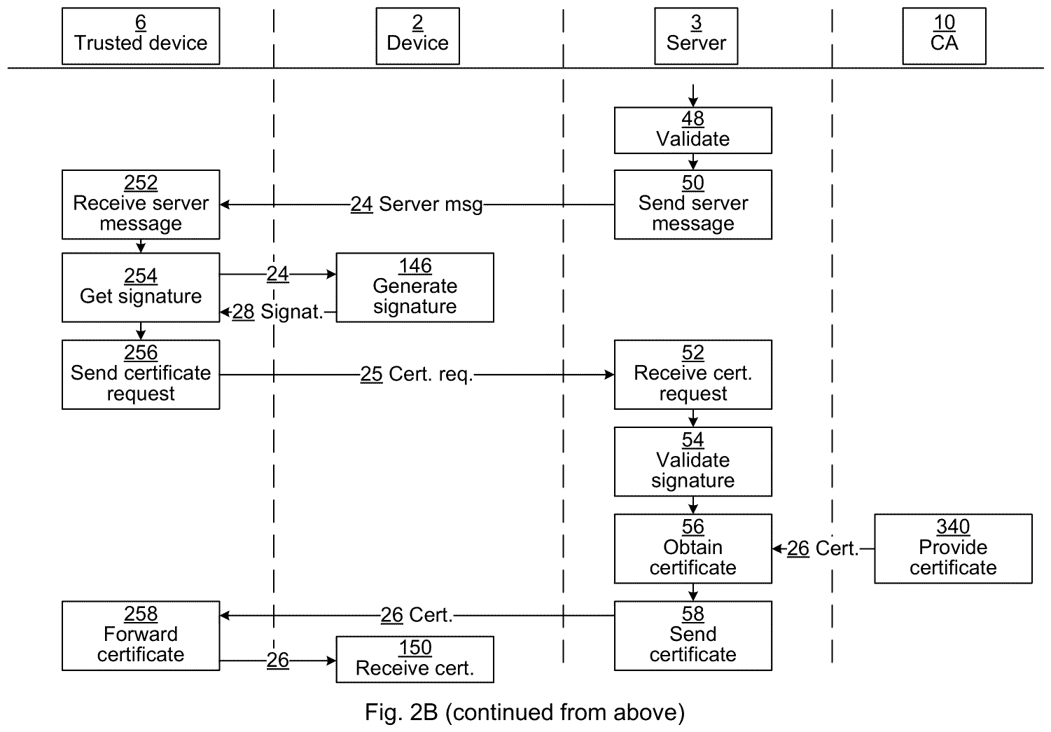

The trusted device 6 can be of different types depending on the context. For instance, the trusted device 6 can be a server that controls issuance of certificates for mobiles (or any device that can connect directly to the service). This type of trusted device is particularly applicable to the embodiment shown in FIG. 2A, described below. Alternatively, the trusted device is a production line tool with ability to directly control the creation of tokens, which is particularly applicable to the embodiment shown in FIG. 2B, described below.

The device 2 and the server 3 are collectively denoted as a system 1 herein.

FIGS. 2A-B are swimlane diagrams illustrating communication between various entities of embodiments which can be applied in the environment of FIG. 1 for obtaining a certificate for the device 2. The steps performed by each one of the entities in FIGS. 2A-B can be thought of as a method performed by that entity. First, the methods illustrated by FIG. 2A will be described.

In a send token request step 240, the trusted party or device 6 sends a token request 20 to the server 3. The token request 20 optionally comprises, for example, a common name or any dynamic data that should be included in the certificate that is eventually going to be provided for the device 2. Optionally, the token request 20 comprises configuration details for the certificate. The configuration details can be directly defined, or the configuration details can be provided by referring to a template comprising the configuration details that the trusted device 6 would like to be applied for the certificate. The configuration details can, for example, define the type of certificate to create, for example, a device TLS (Transport Layer Security) certificate. The configuration details can also define which CA will ultimately provide the certificate. The configuration details can also define the attestation controls that are required to get a certificate of that type and whether the certificate should have a new or inherited device identifier.

Such a device identifier is here applied as a proprietary field in a certificate, such as an X.509 certificate, a C.509 certificate, a proprietary certificate, etc., that contains a unique ID for the device for which the certificate was issued. By choosing the device identifier strategy to inherit the device identifier from a Device Attestation Certificate, it is possible to generate multiple certificates for multiple different purposes for a single device while still being able to tie all the certificates to the same device.

This in turn enables other mechanisms, such as being able to revoke all certificates on a device by only revoking the device Identity Certificate (IDC). For example, consider the scenario where the certificate used for device communication is created by a CA that does not keep a record of issued certificates or does not allow the revocation of issued certificates, it would here still be possible for the entity that manages a device to revoke the certificate by revoking the IDC. An entity that would want to check on the revocation status of a certificate could then query the server 3 about the revocation status for a device based on the device identifier.

In a receive token request step 40, the server 3 receives a token request for a session token from a trusted party 6.

In an obtain session token step 42, the server 3 obtains a session token. The session token is a data item that can, for example, be generated by the server 3 or the server 3 can request the session token from another entity.

In provide token message step 44, the server 3 provides a token or session message 21 comprising the session token to the trusted party 6. Optionally, the token message 21 comprises a nonce. The session message 21 is received by the trusted device 6 in the receive token or session message step 242.

In a provide token message step 244, the trusted device 6 provides the session message 21 to the device 2, where the session message 21 is received by the device 2 in the receive session message step 140.

In a generate key pair step 142, the device 2 generates a key pair comprising a public key and a private key. It is this public key that should later be the base for the certificate.

In a provide validation msg. (message) step 143, the device 2 generates and transmits a validation message. The validation message comprises the session token and the public key of the device 2.

In a receive validation msg. step 46, the server 3 receives the validation message (comprising the public key and the session token) from the device 2.

In an optional send attestation token step 144, the device 2 sends an attestation token to the server 3. The attestation token comprises the nonce and the public key, and optionally other attestation data, to ensure replay protection and tying the public key to the device generating the attestation. The attestation tokens come in two variants, one for device attestation and one for application attestation. FIG. 2A illustrates embodiments that are compatible with application attestation.

Application attestation can be provided in the form of the attestation tokens generated by application marketplaces, such as Google Play and Apple App Store. Such attestation tokens assert that the application sending the attestation token is a certain application, for example, of a specific or trusted application provider, such as a specific manufacturer.

In an optional receive attestation token step 47, the server 3 receives an attestation token for authenticating the device 2.

In a validate step 48, the server 3 validates that the received session token matches the session token provided to the trusted party 6 or by validating a signature based on the session token. If the validation fails, the method ends. The server 3 can also place additional conditions on proceeding. For instance, the validating the device can comprise validating that the session token has not been used before by the server 3 when obtaining a certificate. In this way, the server can enforce that each session token can only be used to provide a single certificate. This provides fine-grained control over exactly how many certificates are issued, as devices 2 that are untrusted can only request a certificate while providing a session token that is generated on the request from a trusted device.

When an attestation token is received by the server 3, the validating the device 2 comprises validating the attestation token, and validating that the key pair was generated by the device.

The optional attestation token is used to ensure that only trusted devices (e.g., of a specific manufacturer) and applications can get certificates. In this way, even if an unused session token were to be obtained by an attacker, the attacker cannot use the session token to issue a certificate for anything other than the specific app(s) (not instance of app, but rather the identity of the application that is common across user devices) or device type that was specified by the trusted device 6 when requesting the session token.

This attestation enables control, using cryptographic security, and ensures that the server only accepts certificate requests from a specific manufacturer. This can also be narrowed down to a specific application by a specific manufacturer, enabling great control over granularity from wide to very narrow.

In a send server message step 50, the server 3 sends a server message to the device 2. The purpose of the server message 24 is to verify that the device 2 has access to the private key corresponding to the public key.

In a receive server message step 145, the device 2 receives the server message 24 and in a generate signature step 146, the device 2 generates a cryptographic signature of the server message based on the private key.

In a send certificate request step 148, the device 2 transmits a certificate request 25 to the server 3. The certificate request comprises the cryptographic signature (of the server message).

In a receive cert. (certificate) request step 52, the server 3 receives a certificate request comprising the cryptographic signature.

In a validate signature step 54, the server 3 validates the cryptographic signature based on the public key. Since it was the server 3 that sent the server message 24 before, the server 3 does not need to receive the server message 24 from the device 2, as long as the server message 24 is temporarily stored by the server, between the times of sending the server message 24 and receiving the certificate request 25. When the validation of the signature is successful, this proves that the device 2 has access to the private key corresponding to the public key. On the other hand, if the validation of the signature fails, the method ends.

In an obtain certificate step 56, the server 3 requests a certificate for the public key from a CA (certificate authority) server 10. The CA server 10 generates the certificate and provides the certificate 26 in a provide certificate step 340. The server 3 then receives the certificate 26 from the CA server in an obtain certificate step 56. Since the server 3 is provided between the certificate requester (the device 2 in this case) and the CA 10, the server can be customized to any of several different CAs. In other words, the server 3 can provide access to certificates from several different CAs, while hiding any differences and complexities from the certificate requester.

In a send certificate step 58, the server 3 sends the certificate to the device 2, such that the device 2 receives the certificate 26 in a receive certificate step 150.

Once the device 2 is in possession of the certificate 26, the certificate can be used for any suitable purpose, such as firmware management, communication, etc.

Looking now to FIG. 2B, this illustrates methods that are similar to the methods illustrated by FIG. 2A, but where the device is a physical device that supports entity attestation tokens. In the interest of focus and brevity, only differences compared to what is illustrated by FIG. 2A will be described. In this embodiment, the device 2 can be a device with communication abilities.

As mentioned above, the trusted device 6 here can be a production line tool with ability to directly control the creation of tokens. Optionally, roles of the trusted device can be split based on function, such that the trusted device 6 for session management is a server, while the trusted device 6 is the production line tool for other functions.

Here, the token message 21 is sent from the server 3 to the trusted device 6. Instead of the device 2 generating a key pair, the device is already provisioned with a key pair. Hence, the device 2 supports device attestation, for example, in the form of Entity Attestation Tokens (EAT, see https://datatracker.ietf.org/doc/draft-ietf-rats-eat/) that attest that the public key belongs to a key pair that was generated on a device that has a Device Attestation Certificate that is trusted by the server 3, for example, of a specific manufacturer. When provided in the token message 21, the trusted device 6 provides the nonce to the device 2, which includes the nonce in the EAT. Using EAT, in this way, rogue devices cannot obtain a certificate through the server 3. Hence, the device 2 provides the attestation token 23 to the trusted device 6 in a provide attestation token step 141. The trusted device 6 receives the attestation token 23 in the get attestation token step 246. The get attestation token step 246 can also include a prior request to the device 2 to provide the attestation token 23. The attestation token 23 here includes a public key of the device 2, where the device also has access to a private key corresponding to the public key, such that the private key and the public key form a key pair.

According to embodiments illustrated by FIG. 2B, it is the trusted device 6 that sends the validation message 22 to the server 3 in a provide validation message step 248. It is also the trusted device 6 that optionally sends the attestation token 23 to the server 3 in an optional send attestation token step 250.

The server here sends the server message 24 to the trusted device 6, which receives the server message 24 in a receive server message step 252. In order to get the signature of the server message 24, the trusted device communicates with the device 2 in a get signature step 254 and the device 2 cooperates in a generate signature step 146. Specifically, the trusted device 6 provides the server message 24 to the device, that signs the server message 24 with its private key corresponding to the public key of the attestation token, and sends the signature 28 to the trusted device 6. At this point, the trusted device 6 has all the data needed to send the certificate request 25 to the server 3 in a send certificate request step 256.

Once the certificate is available at the server 3, the server sends the certificate 26 to the trusted device 6 that forwards the certificate 26 to the device in a forward certificate step 258.

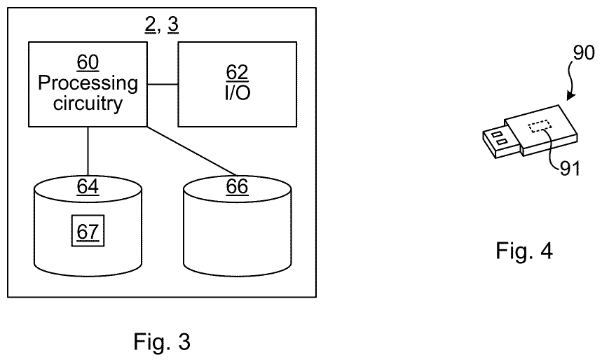

FIG. 3 is a schematic diagram illustrating components of the device 2 and the server 3 of FIG. 1. Processing circuitry 60 is provided using any combination of one or more of a suitable central processing unit (CPU), graphics processing unit (GPU), multiprocessor, neural processing unit (NPU), microcontroller, digital signal processor (DSP), etc., capable of executing software instructions 67 stored in memory circuitry 64, which can thus be a computer program product. The processing circuitry 60 could alternatively be implemented using an application specific integrated circuit (ASIC), field programmable gate array (FPGA), etc. The processing circuitry 60 can be configured to execute the methods described with reference to FIGS. 2A-B above.

The memory circuitry 64 can be any combination of random-access memory (RAM) and/or read-only memory (ROM). The memory circuitry 64 also comprises non-transitory persistent storage, which, for example, can be any single one or combination of magnetic memory, optical memory, solid-state memory or even remotely mounted memory.

A data memory 66 is also provided for reading and/or storing data during execution of software instructions in the processing circuitry 60. The data memory 66 can be any combination of RAM and/or ROM.

An I/O interface 62 for communicating with external and/or internal entities. Optionally, the I/O interface 62 also includes a user interface.

Other components are omitted in order not to obscure the concepts presented herein.

FIG. 4 shows one example of a computer program product 90 comprising computer readable means. On this computer readable means, a computer program 91 can be stored in a non-transitory memory. The computer program can cause processing circuitry to execute a method according to embodiments described herein. In this example, the computer program product 90 is in the form of a removable solid-state memory, e.g. a Universal Serial Bus (USB) drive. As explained above, the computer program product could also be embodied in a memory of a device, such as the computer program product 64 of FIG. 3. While the computer program 91 is here schematically shown as a section of the removable solid-state memory, the computer program can be stored in any way which is suitable for the computer program product, such as another type of removable solid-state memory, or an optical disc, such as a CD (compact disc), a DVD (digital versatile disc) or a Blu-Ray disc.

The aspects of the present disclosure have mainly been described above with reference to a few embodiments. However, as is readily appreciated by a person skilled in the art, other embodiments than the ones disclosed above are equally possible within the scope of the invention, as defined by the appended patent claims. Thus, while various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims.

1. A method for obtaining a certificate for a device of a system comprising the device and a server, the method being performed by the server, the method comprising:
providing a token message comprising a session token to a trusted party;
receiving a validation message comprising data based on the session token and a public key of a key pair of the device, the key pair comprising the public key and a private key;
validating the device, which comprises validating that the received data based on the session token corresponds to the session token provided to the trusted party;
sending a server message to the device;
receiving a certificate request comprising a cryptographic signature;
validating that the cryptographic signature is a signature of the server message, based on the public key;
obtaining a certificate from a certificate authority server; and
sending the certificate to the device.

2. The method according to claim 1, further comprising:
receiving a token request for the session token from the trusted party; and
obtaining the session token;
wherein the token message comprises the obtained session token.

3. The method according to claim 1, wherein the validating the device comprises validating that the session token has not been used before by the server when obtaining a certificate.

4. The method according to claim 1, further comprising:
receiving an attestation token for authenticating the device;
wherein the validating the device comprises validating the attestation token.

5. The method according to claim 4, wherein the token message further comprises a nonce, and the attestation token is an entity attestation token comprising the nonce.

6. The method according to claim 4, wherein the validating the attestation token comprises validating that the attestation token indicates that a source of an application of the device that sends the validation message matches a list of at least one pre-defined valid application.

7. The method according to claim 2, wherein the token request comprises configuration details for the certificate.

8. The method according to claim 1, wherein the data based on the session token is the session token and wherein the validating that the received data based on the session token corresponds to the session token provided to the trusted party comprises matching the received session token against the session token provided to the trusted party.

9. The method according to claim 1, wherein the data based on the session token is a signature based on the session token and wherein the validating that the received data based on the session token corresponds to the session token provided to the trusted party comprises matching the signature against the session token provided to the trusted party.

10. A server for obtaining a certificate for a device of a system comprising the device and the server, the server comprising:
processing circuitry; and
memory circuitry storing instructions that, when executed by the processing circuitry, cause the server to:
provide a token message comprising the session token to the trusted party;
receive a validation message comprising data based on the session token and a public key of a key pair of the device, the key pair comprising the public key and a private key;
validate the device, which comprises validating that the received session data based on the session token corresponds to the session token provided to the trusted party;
send a server message to the device;
receive a certificate request comprising a cryptographic signature;
validate that the cryptographic signature is a signature of the server message, based on the public key;
obtain a certificate from a certificate authority server; and
send the certificate to the device.

11. The server according to claim 10, further comprising instructions that, when executed by the processing circuitry, cause the server to:
receive a token request for the session token from the trusted party; and
obtain the session token;
wherein the token message comprises the obtained session token.

12. The server according to claim 10, wherein the instructions to validate the device comprise instructions that, when executed by the processing circuitry, cause the server to validate that the session token has not been used before by the server when obtaining a certificate.

13. The server according to claim 10, further comprising instructions that, when executed by the processing circuitry, cause the server to:
receive an attestation token for authenticating the device;
wherein the instructions to validate the device comprise instructions that, when executed by the processing circuitry, cause the server to validate the attestation token.

14. The server according to claim 13, wherein the token message further comprises a nonce, and the attestation token is an entity attestation token comprising the nonce.

15. The server according to claim 13, wherein the instructions to validate the attestation token comprise instructions that, when executed by the processing circuitry, cause the server to validate that the attestation token indicates that a source of an application of the device that sends the validation message matches a list of at least one pre-defined valid application.

16. The server according to claim 11, wherein the token request comprises configuration details for the certificate.

17. The server according to claim 10, wherein the data based on the session token is the session token and wherein the instructions to validate that the received data based on the session token corresponds to the session token provided to the trusted party comprise instructions that, when executed by the processing circuitry, cause the server to match the received session token against the session token provided to the trusted party.

18. A method for obtaining a certificate for a device of a system comprising the device and a server, the method being performed by the device, the method comprising:
receiving a token message from a trusted party, the token message comprising a session token;
providing, by the device, a public key of a key pair comprising the public key and a corresponding private key;
generating and transmitting a validation message, wherein the validation message comprises the session token and the public key;
receiving a server message from the server;
generating a cryptographic signature of the server message based on the private key;
sending a certificate request to the server, wherein the certificate request comprises the cryptographic signature; and
receiving the certificate.

19. The method according to claim 18, wherein the providing a public key comprises generating the key pair comprising the public key and the private key.
